(19) United States
(12) Patent Application Publication
(10) Pub. No.: US 2018/0113377 A1
(43) Pub. Date: Apr. 26, 2018

(54) SIGNAL TRANSMISSION METHOD AND SWITCHING METHOD OF WATERPROOF CONNECTOR FOR CAMERA

(71) Applicants: CUHN HUA HSIA, New Taipei City (TW); YUNG SHENG WANG, New Taipei City (TW)

(72) Inventors: CUHN HUA HSIA, New Taipei City (TW); YUNG SHENG WANG, New Taipei City (TW)

(21) Appl. No.: 15/298,245

(22) Filed: Oct. 20, 2016

(51) Int. Cl. G03B 17/08; H01R 13/405; H01R 13/52; H01R 13/66; H04N 7/04; H04N 5/225; H04N 5/44; H04N 5/38; H04B 5/00

(52) U.S. Cl. CPC G03B 17/08; H01R 13/405; H01R 13/5216; H01R 13/665; H04B 5/0087; H04N 5/2252; H04N 5/44; H04N 5/38; H04N 5/2254; H04N 7/04

(57) ABSTRACT

A signal transmission method and switching method of a waterproof connector for camera, including a lens and a bodywork. The lens contains a coupling end, the coupling end has the first NFC transmitter module and the first magnetic induction receiver module. The bodywork contains an abutting end, the abutting end has the first NFC receiver/transmitter module which receives video from the first NFC transmitter module, and the abutting end has the first magnetic induction transmitter module which transmits power to the first magnetic induction receiver module by wireless transmission. The lens is connected to the bodywork by wireless transmission, so that the lens is sealed completely for waterproofing.

### BACKGROUND OF INVENTION

### 1. Field of the Invention

The present invention relates generally to a waterproof connector, and more particularly to the signal transmission method and switching method of a waterproof connector for camera.

### 2. Description of Related Art

As normal persons cannot feel the distance behind the vehicle, the reversal monitoring device is developed by modern technology, so that the driver can master the obstacles behind the vehicle easily to avoid collisions.

The main unit of car audio is installed in the instrument panel of car to provide the audio playing function. The advanced car video host is connected to a touch screen which can play videos. At present, the car audio hosts designed with a TFT LCD screen have been connected to the rear view camera by wired connection. When the rear view camera shoots the reversal, the vision behind the car is transmitted to the host display screen for monitoring safe driving. However, in the wire connection mode, the waterproof part cannot be sealed completely, so that the water seeps in the lens, which shall be improved.

### SUMMARY OF THE INVENTION

In view of said known problem, the fundamental purpose of the present invention is to connect the lens to the bodywork by wireless transmission, so that the lens is sealed completely for waterproofing.

In order to attain said purpose, the present invention provides a signal transmission method of waterproof connector for camera, including the following steps: to provide a lens with the first NFC transmitter module and the first magnetic induction receiver module; to provide a bodywork with the first NFC receiver/transmitter module and the first magnetic induction transmitter module; the first magnetic induction transmitter module of the bodywork transmits power to the first magnetic induction receiver module by wireless transmission; and the first NFC receiver/transmitter module of the bodywork receives the video from the first NFC transmitter module. The lens is connected to the bodywork by wireless transmission, so that the lens is sealed completely for waterproofing.

According to an embodiment of the present invention, the coupling end is connected to the first induction coil, the abutting end is connected to the second induction coil, the second induction coil transmits power to the first induction coil.

According to an embodiment of the present invention, the coupling end is a plug electric connector, the abutting end is a socket electric connector for the plug electric connector to plug in.

According to an embodiment of the present invention, the coupling end and abutting end contain fasteners for clamping each other.

According to an embodiment of the present invention, the first magnetic induction receiver module and the first magnetic induction transmitter module are of WPC transmission standard.

The present invention also provides a switching method of waterproof connector for camera, including the following steps: to provide a first adapter abutting the lens, the first adapter has the second NFC transmitter module and the second magnetic induction receiver module; and to provide a second adapter abutting the bodywork, the second adapter has a second NFC receiver/transmitter module for receiving the video from the second NFC transmitter module, the second adapter has a second magnetic induction transmitter module which delivers power to the second magnetic induction receiver module by wireless transmission.

### BRIEF DESCRIPTION OF THE DRAWINGS

FIG. 1 is the flow chart of the signal transmission method of the present invention.

FIG. 2 is the schematic diagram of the appearance of vehicle using the present invention.

FIG. 3 is the structural representation of the first embodiment of the present invention.

FIG. 4 is the schematic diagram of appearance of socket electric connector and plug electric connector in the first embodiment of the present invention.

FIG. 5 is the schematic lateral section of socket electric connector and plug electric connector in the first embodiment of the present invention.

FIG. 6 is the flow chart of the switching method of the present invention.

FIG. 7 is the structural representation of the second embodiment of the present invention.

### DETAILED DESCRIPTION OF THE INVENTION

The implementation of the present invention is described below by embodiments, the persons familiar with this technique can understand the other advantages and efficacy of the present invention easily from the content disclosed in this specification.

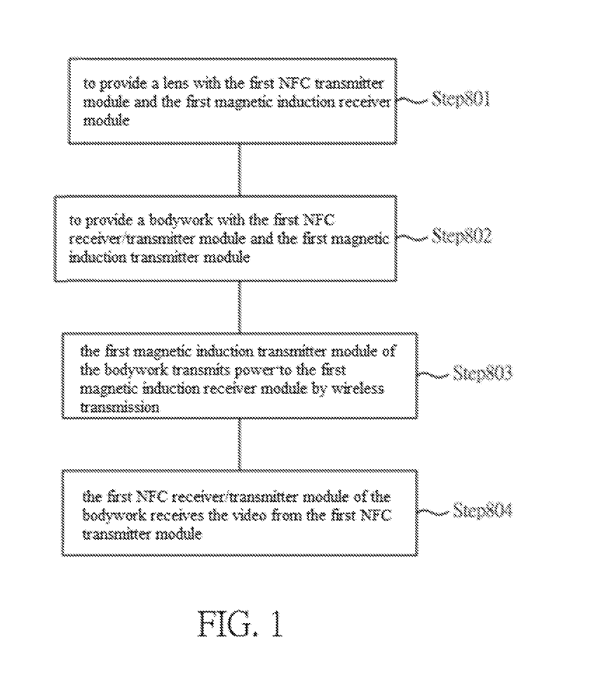

FIG. 1 is the flow chart of signal transmission method, it is the signal transmission method of waterproof connector for camera of the present invention, including the following steps:

Step 801: to provide a lens 1 with the first NFC transmitter module 12 and the first magnetic induction receiver module 14;

Step 802: to provide a bodywork 2 with the first NFC receiver/transmitter module 22 and the first magnetic induction transmitter module 24;

Step 803: the first magnetic induction transmitter module 24 of the bodywork 2 transmits power to the first magnetic induction receiver module 14 by wireless transmission;

Step 804: the first NFC receiver/transmitter module 22 of the bodywork 2 receives the video from the first NFC transmitter module 12.

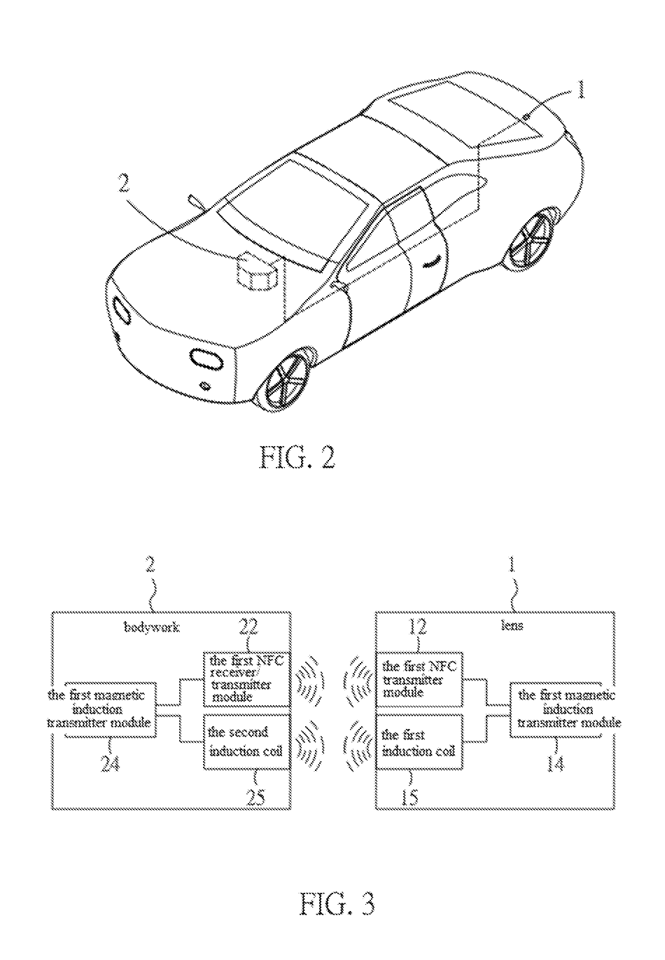

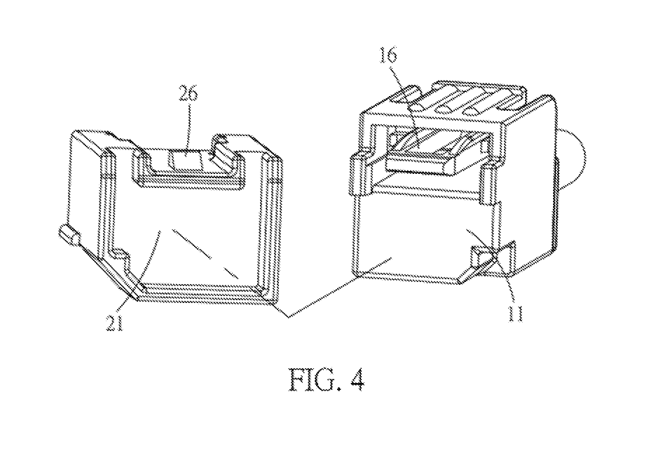

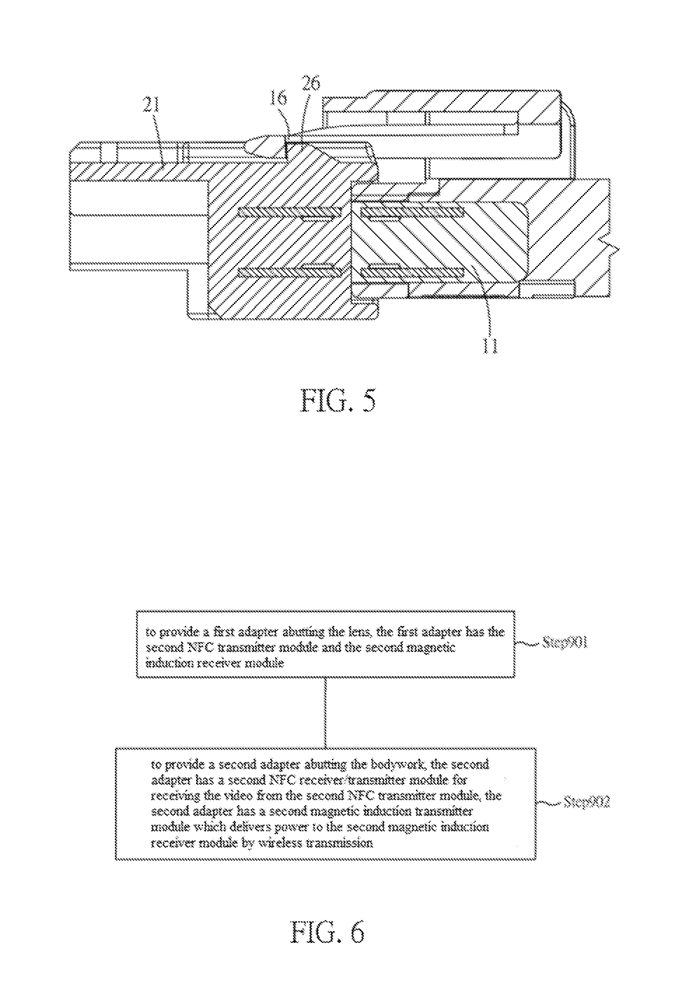

Referring to FIGS. 2 to 5, FIG. 2 is the schematic diagram of the appearance of the vehicle. FIG. 3 is the structural representation of the first embodiment. FIG. 4 is the schematic diagram of the appearance of socket electric connector and plug electric connector in the first embodiment. FIG. 5 is the schematic lateral section of socket electric connector and plug electric connector in the first embodiment. It is the first embodiment of signal transmission method of waterproof connector for camera of the present invention. The present invention proposes a signal transmission method of waterproof connector for camera, including lens 1 and bodywork 2. The lens 1 contains coupling end 11, the coupling end 11 is plug electric connector or socket electric connector. The coupling end 11 has the first NFC transmitter module 12 and the first magnetic induction receiver module 14. The first NFC transmitter module 12 is a chip assembled on the circuit board. The first magnetic induction receiver module 14 is a chip assembled on the circuit board. The circuit board can be assembled in the plug electric connector or socket electric connector, the sealing is completed by injection molding to avoid moisture infiltration.

Referring to FIGS. 2 to 5, in this embodiment, the bodywork 2 contains abutting end 21. The abutting end 21 is socket electric connector or plug electric connector. The abutting end 21 has the first NFC receiver/transmitter module 22 which receives the video from the first NFC transmitter module 12. The first NFC receiver/transmitter module 22 is a chip assembled on the circuit board. The abutting end 21 has the first magnetic induction transmitter module 24 which transmits power to the first magnetic induction receiver module 14 by wireless transmission. The first magnetic induction transmitter module 24 is a chip assembled on the circuit board. The circuit board can be assembled in the plug electric connector or socket electric connector. The sealing is completed by injection molding to avoid moisture infiltration. The first magnetic induction receiver module 14 and the first magnetic induction transmitter module 24 are a WPC transmission standard (Wireless Power Consortium), which is an interconnection standard of short distance low power wireless induction power transmission.

Referring to FIGS. 2 to 5, in this embodiment, the coupling end 11 is connected to the first induction coil 15. The abutting end 21 is connected to the second induction coil 25. The second induction coil 25 transmits power to the first induction coil 15.

Referring to FIGS. 2 to 5, in this embodiment, the coupling end 11 and abutting end 21 contain fasteners 16 and 26 clamping each other, the coupling end 11 and abutting end 21 are fixed by the fasteners 16 and 26 clamping each other.

Referring to FIGS. 2 to 5, in this embodiment, the external vision is shot by lens 1, the video signal is sent by the first NFC transmitter module 12 of lens 1 to the first NFC receiver/transmitter module 22 of bodywork 2, and displayed on the screen connected to bodywork 2.

Referring to FIGS. 2 to 5, in this embodiment, the bodywork 2 supplies power to the lens for operation. The first magnetic induction transmitter module 24 of bodywork 2 transmits power to the first induction coil 15 by wireless transmission via the second induction coil 25. The first induction coil 15 receives power and transmits it to the first magnetic induction receiver module 14 for the lens 1 and the first NFC transmitter module 12.

Referring to FIG. 6, which is the flow chart of switching method, the switching method of waterproof connector for camera comprises the following steps:

Step 901: to provide a first adapter 4 abutting lens 1, the first adapter 4 has the second NFC transmitter module 42 and the second magnetic induction receiver module 44;

Step 902: to provide a second adapter 5 abutting bodywork 2, the second adapter 5 has a second NFC receiver/transmitter module 52 which receives video from the second NFC transmitter module 42. The second adapter 5 has a second magnetic induction transmitter module 54 which transmits power to the second magnetic induction receiver module 44 by wireless transmission.

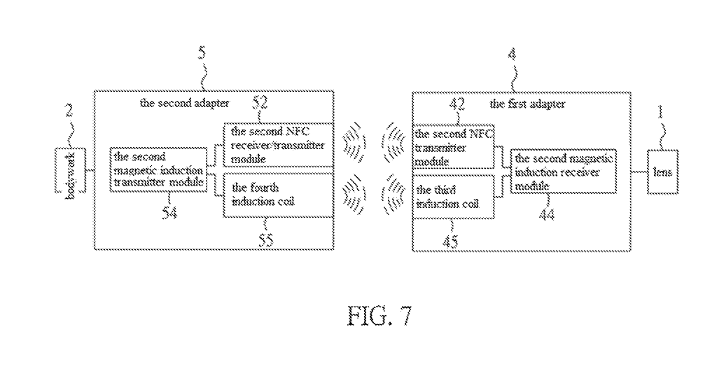

Referring to FIG. 7, it is the second embodiment of the present invention. The difference of this embodiment from the first embodiment is this embodiment is the switching device for the signal transmission method of waterproof connector for camera; namely, the switching device is used as the connection interface between lens 1 and bodywork 2. The lens 1 and bodywork 2 are general connection mode with real wire, the lens 1 and bodywork 2 are connected to the switching device respectively.

Referring to FIG. 6, in this embodiment, the switching device contains the first adapter 4 and the second adapter 5. The first adapter 4 abuts lens 1. The first adapter 4 has the second NFC transmitter module 42 and the second magnetic induction receiver module 44. The second adapter 5 abuts bodywork 2. The second adapter 5 has the second NFC receiver/transmitter module 52 which receives video from the second NFC transmitter module 42. The second adapter 5 has the second magnetic induction transmitter module 54 which transmits power to the second magnetic induction receiver module 44 by wireless transmission.

Referring to FIG. 6, in this embodiment, the first adapter 4 is connected to the third induction coil 45, the second adapter 5 is connected to the fourth induction coil 55, the fourth induction coil 55 transmits power to the third induction coil 45. The bodywork 2 supplies power to lens 1 for operation. The bodywork 2 transmits power to the second adapter 5 via wire. The second magnetic induction transmitter module 54 of the second adapter 5 transmits power to the third induction coil 45 by wireless transmission via the fourth induction coil 55. The third induction coil 45 transmits power to the second magnetic induction receiver module 44 of the first adapter 4. The first adapter 4 transmits power to lens 1 via wire.

Said detailed description fully shows that the purpose and efficacy of the present invention have evolutionarity of implementation, there is great industrial utility value, and this invention has not yet been seen on the market, completely meeting the patent essentials, so the application is submitted according to law. However, the above statement is merely the preferred embodiments of the present invention, which shall not limit the scope of implementation of the present invention. Any equal change and modification made according to the scope of patent of the present invention shall be within the scope of patent of the present invention.

1. A signal transmission method of waterproof connector for camera comprises the following steps:
to provide a lens with the first NFC transmitter module and the first magnetic induction receiver module;
to provide a bodywork with the first NFC receiver/transmitter module and the first magnetic induction transmitter module;
the first magnetic induction transmitter module of the bodywork transmits power to the first magnetic induction receiver module by wireless transmission; and the first NFC receiver/transmitter module of the bodywork receives video from the first NFC transmitter module.

2. The signal transmission method of waterproof connector for camera as claimed in claim 1, wherein the lens has a first induction coil, the bodywork has a second induction coil, the second induction coil transmits power to the first induction coil.

3. The signal transmission method of waterproof connector for camera as claimed in claim 1, wherein the lens has a plug electric connector, the bodywork has a socket electric connector for the plug electric connector to plug in.

4. The signal transmission method of waterproof connector for camera as claimed in claim 1, wherein the lens and the bodywork contain a fastener respectively for clamping each other.

5. The signal transmission method of waterproof connector for camera as claimed in claim 1, wherein the first magnetic induction receiver module and the first magnetic induction transmitter module are a WPC transmission standard.

6. A switching method of waterproof connector for camera, including the following steps:
to provide a first adapter abutting the lens, the first adapter has the second NFC transmitter module and the second magnetic induction receiver module; and to provide a second adapter abutting the bodywork; the second adapter has a second NFC receiver/transmitter module for receiving the video from the second NFC transmitter module; the second adapter has a second magnetic induction transmitter module which delivers power to the second magnetic induction receiver module by wireless transmission.

7. The switching method of waterproof connector for camera as claimed in claim 6, wherein the first adapter has a third induction coil, the second adapter has a fourth induction coil, the fourth induction coil transmits power to the third induction coil.

8. The switching method of waterproof connector for camera as claimed in claim 6, wherein the first adapter has a plug electric connector, the second adapter has a socket electric connector for the plug electric connector to plug in.

9. The switching method of waterproof connector for camera as claimed in claim 6, wherein the first adapter and the second adapter contain a fastener respectively for clamping each other.

10. The switching method of waterproof connector for camera as claimed in claim 6, wherein the second magnetic induction receiver module and the second magnetic induction transmitter module are a WPC transmission standard.
